(19) United States
(12) Patent Application Publication
(10) Pub. No.: US 2006/0044688 A1
(43) Pub. Date: Mar. 2, 2006

(54) Magnetic disk with protection film and magnetic disk manufacturing method

(75) Inventors: Yuichi Kokaku, Kanagawa (JP); Tomonori Kozaki, Kanagawa (JP); Toshinori Ono, Tokyo (JP); Kazuhiro Ura, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/215,533

(22) Filed: Aug. 29, 2005

(30) Foreign Application Priority Data
Aug. 30, 2004 (JP) 2004-250134

(51) Int. Cl. G11B 5/82

(52) U.S. Cl. 360/135

(57) ABSTRACT

Embodiments of the invention provide a magnetic disk capable of maintaining a satisfactory sliding resistance and having a high corrosion resistance and a manufacturing method thereof. The magnetic disk and the manufacturing method thereof are realized by forming a protection film having a less film thickness distribution on a magnetic film surface, particularly by reducing a film thickness distribution in a load/unload zone in addition to a reduction in film thickness of the protection film. In one embodiment, a shortest distance between a substrate and a supporting member is 10 mm or more in a step of forming the protection film, the substrate being mounted on a holder having claws for holding the substrate and supporting members for supporting the claws. In addition, the method is characterized by chamfering the face confronting the substrate of the supporting member and setting the shortest distance between the substrate and the supporting member to 5 mm or more.

### CROSS-REFERENCES TO RELATED APPLICATIONS

This application claims priority from Japanese Patent Application No. JP2004-250134, filed Aug. 30, 2004, the entire disclosure of which is incorporated herein by reference.

### BACKGROUND OF THE INVENTION

The present invention relates to a magnetic disk to be installed in a disk storage unit and a method for manufacturing the magnetic disk, the method comprising a step of forming a protection film by chemical vapor deposition (hereinafter referred to as CVD).

Due to the expansion of the use of computers, improvement in recording density of a disk storage unit serving as an external storage device is in demand. In order to develop the disk storage unit having improved recording density, a high recording density of a magnetic disk which is a main component to be incorporated into the device is in demand. As one of means for increasing the recording density, a method of ensuring intensity of read signal by reducing a distance between a magnetic head used for data reading/writing from/on the magnetic disk and a magnetic disk is considered to be effective. The distance consists of a head flying height, a protection film thickness, and a lubricant film thickness. Therefore, in order to realize the high recording density, the protection film of the magnetic disk should be as thin as possible.

The mainstream method which has heretofore been used for the disk storage unit is the CSS (Contact Start Stop) method. In this method, the magnetic head waits at a region having a partial projection when the power is not turned on. However, with the method, the magnetic head can adhere to the magnetic disk in the course of flying of the magnetic head, and the protection film of the magnetic head is subject to abrasion.

As a result, in order to prevent the above problems, a load/unload mechanism has become the mainstream method. In this method, the magnetic head waits on a ramp formed outside the magnetic disk when the data reading/writing operations are not performed, and loaded onto the magnetic disk only when a read command or a write command is output. With this method, however, the magnetic head can contact the magnetic disk in a region over which the magnetic head moves onto the magnetic disk from the ramp, i.e., in a load/unload zone in an outer radial edge as viewed from the center of the magnetic disk. Therefore, a protection film having greater strength to endure an impact caused by the loading of the magnetic head is in demand.

As a method of forming a protection film of a magnetic disk, sputtering vapor deposition which is a type of PVD (Physical Vapor Deposition) has mainly been used. However, when a protection film thickness is 4 nm or less, it is difficult to ensure endurance and corrosion resistance thereof with the method. Accordingly, a film formation by CVD has become the mainstream method for forming the thin protection film since the method enables formation of a higher density film. Examples of the CVD include IBD (Ion Beam Deposition) wherein plasma is generated by using as an electron source a thermal filament, a method using a radio frequency, and a method using electron cyclotron resonance (ECR). Although it is possible to obtain a thinner protection film having a higher strength by the protection film formation by the CVD, the method is subject to a film thickness distribution. Also, a low degree of the film thickness distribution which has not been problematic is now considered to be a problem due to the film thickness reduction. In order to suppress the film thickness distribution, it is necessary to uniformly irradiate a substrate on which an underlying layer and a magnetic film have been formed with the plasma. Further, since it is necessary to apply a bias voltage to the substrate in each of magnetic disk manufacturing process steps, the film thickness distribution is inevitably formed around a supporting member made from a metal material to which the bias is applied.

The film thickness distribution entails problems such as a head crush due to degradation in sliding resistance in the thin portion and head contamination due to corrosion, and, in the case where the thick portion is formed in a data region, reading/writing performances are partially degraded.

A method for solving a longitudinal distribution in the protection film formation using the CVD is proposed in Patent Literature 1 (JP-A-2003-30823). Patent Literature 1 suggests that the method is capable of achieving a uniform longitudinal thickness by providing a film formation apparatus for forming protection films with a film thickness distribution control plate and irradiating a magnetic disk uniformly with plasma inside a chamber. Further, Patent Literature 1 proposes an increase in thickness of the load/unload zone in order to achieve strength capable of coping with a head contact at the time of incorporation of the load/unload type drive device.

### BRIEF SUMMARY OF THE INVENTION

Recently, the hard disk has found a wider range of applications in addition to personal computers, such as a car navigation system and a car audio as being mounted on a vehicle. In order to cope with severe ambient temperature and humidity, it is increasingly necessary to further improve a corrosion resistance of the magnetic disk in addition to the necessity for the reduction in protection film thickness which satisfies the demand for the high recording density.

Accordingly, the inventors have conducted corrosion experiments under a high temperature environment to analyze in detail portions on which the corrosion occurs. The inventors have found by an optical microscopic observation that more calescence points are observed on a portion having partial larger film thickness parts as compared with a portion having a large film thickness. From an element analysis by EDX (Energy Dispersive X-ray Analysis) of substances on the calescence points, a detection of Co has been confirmed. That is to say, the corrosion occurs particularly at the film thickness distribution portion in the load/unload zone where the head is loaded onto the magnetic disk. Therefore, in order to suppress the corrosion, it is necessary to keep the film thickness distribution as small as possible in the load/unload zone of the magnetic disk.

On the other hand, in the protection film formation process steps disclosed in Patent Literature 1, a magnetic disk edge at which the plasma tends to be non-uniform is particularly subject to influences of objects in the vicinity thereof. In particular, the film thickness distribution is frequently caused due to influences of a bias application to the magnetic disk and a supporting member (hereinafter referred to as a finger) made from a metal material and used for supporting a claw for holding the magnetic disk.

Further, with the method disclosed in Patent Literature 1 wherein a thickness of an outer edge portion of a protection film is increased by forming the protection film in two steps, drawbacks such as a possibility of corrosion on the outer edge, degradation in signal reading/writing performances due to the thickened portion of the protection film outside the load/unload zone, a necessity for a large equipment due to two chambers required for the film formation, and a difficulty in film formation evaluation due to the difference between film qualities of the first layer and the second layer of the protection film have been detected.

Accordingly, a feature of this invention is to provide a magnetic disk having a high sliding resistance and a high corrosion resistance by reducing a film thickness of a protection film and forming the protection film on a magnetic film surface with a less film thickness distribution, particularly, with the film thickness distribution in a load/unload zone being reduced, as well as to provide a manufacturing method of such magnetic disk.

In order to solve the above problems, the magnetic disk manufacturing method according to one embodiment of this invention is characterized in that a substrate is mounted on a holder having a claw for holding the substrate and a supporting member for supporting the claw and that a shortest distance between the substrate and the supporting member is 10 mm or more.

Also, the magnetic disk manufacturing method is characterized in that a surface of the supporting member facing the substrate is chamfered and that the shortest distance between the substrate and the supporting member is about 5 mm or more.

Further, the magnetic disk according to an embodiment of this invention is characterized in that the protection film has a film thickness distribution of about 0.3 nm or less in the load/unload zone.

The magnetic disk and the magnetic disk manufacturing method of this invention enable manufacture of magnetic disks improved in corrosion resistance, thereby making it possible to provide disk storage units capable of operating under the conditions of high temperature and high humidity.

### BRIEF DESCRIPTION OF THE DRAWINGS

FIG. 1 is a sectional view showing a magnetic disk of the first embodiment.

FIG. 2 is a flowchart showing a manufacturing method of the magnetic disk of the first embodiment.

FIG. 3 is a diagram showing a position relationship between a substrate and fingers as viewed from a sideface of a film formation chamber.

FIG. 4 is a diagram showing a position relationship between the fingers and the substrate as viewed from above the film formation chamber.

FIG. 5 is a diagram showing a difference between a film thickness average value and a film thickness maximum value in the circumferential direction at a radial position of each of magnetic disks when a value L is 5 mm.

FIG. 6 is a diagram showing a difference between a film thickness average value and a film thickness maximum value in the circumferential direction at a radial position of each of magnetic disks when a value L is 10 mm.

FIG. 7 is a diagram showing a difference between a film thickness average value and a film thickness maximum value in the circumferential direction at a radial position of each of magnetic disks when a value L is 15 mm.

FIG. 8 is a diagram showing a difference between a film thickness average value and a film thickness maximum value in the circumferential direction at a radial position of each of magnetic disks in the second embodiment.

FIG. 9 is a diagram showing a relationship between the value L and the difference between the protection film maximum value and the average value in the circumferential direction.

FIG. 10 is a diagram showing a relationship between the number of calescence points and the difference between the protection film maximum value and the average value in the circumferential direction.

### DETAILED DESCRIPTION OF THE INVENTION

### Embodiment 1

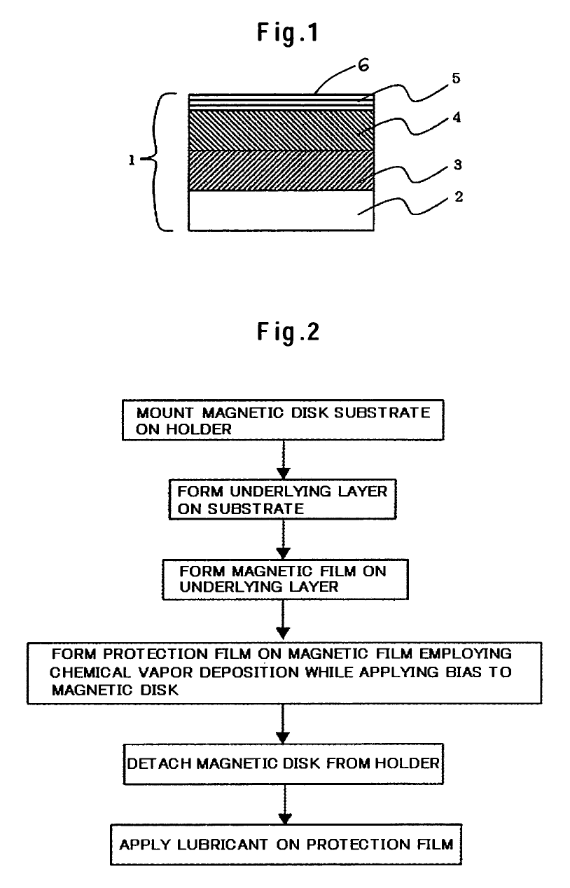

As shown in FIG. 1, a magnetic disk 1 of this embodiment has a rigid substrate 2, an underlying layer 3 formed on the rigid substrate 2, a magnetic film 4 formed on the underlying layer 3, a protection film 5 formed on the magnetic film 4, a lubricant 6 applied on the protection film 5.

As shown in FIG. 2, the magnetic disk 1 of this embodiment is manufactured by process steps of forming by sputtering the underlying layer 3 and the magnetic film 4 in this order on the rigid substrate 2 mounted on a holder having fingers and claws; conveying the magnetic disk 1 to a protection film formation chamber; and forming the protection film 5 mainly containing carbon on the magnetic film 4 by CVD with a bias being applied by way of the holder. After that, the substrate 2 on which the underlying layer 3, the magnetic film 4, and the protection film 5 are formed is detached from the holder, and then the lubricant 6 is applied on the protection film 5.

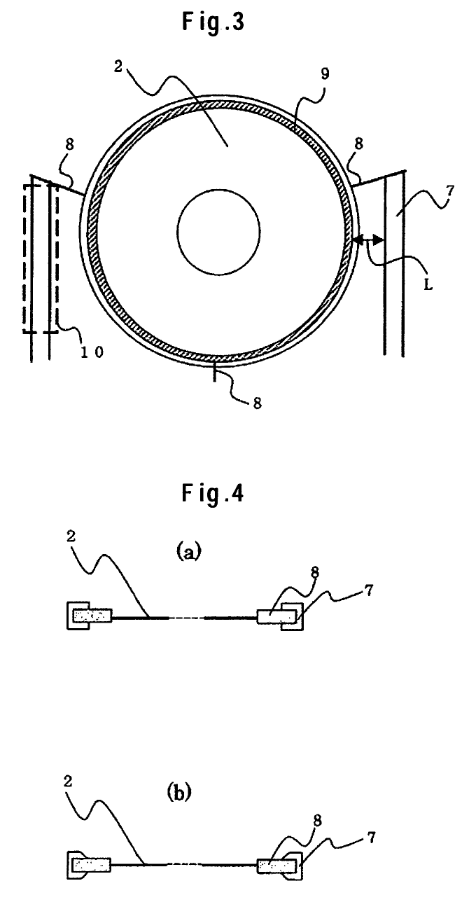

FIG. 3 is a diagram showing a position relationship between the substrate and the fingers as viewed from a sideface of the film formation chamber. As shown in FIG. 3, the substrate 2 is mounted on the holder having the claws 8 for holding the substrate 2 and the fingers 7 for supporting the claws 8. A shortest distance between the substrate 2 and each of the fingers 7 when the substrate 2 is mounted on the holder is indicated by L. The substrates 2 are transported one by one in such a manner that the substrate 2 to be subjected to the film formation is placed inside the film formation chamber by the use of the fingers 7. In the case of forming the protection film 5, the substrate 2 on which the magnetic film is formed is held by the claws 8 attached on tips of the fingers and subjected to the bias application. Referring to FIG. 3, an outer radial edge as viewed from the center of the substrate is a load/unload zone 9. Since the fingers 7 are fixed to the film formation apparatus with bolts in advance of the magnetic disk manufacturing process, a value of L is ordinarily constant. Therefore, in order to change the value L, fingers having different fixing bolt hole positions and finger columns are prepared to form samples with different L values.

The carbon protection film 5 is formed by employing IBD which is a type of the CVD. The IBD is a method of forming a film by way of a hydrocarbon radical surface reaction involving an ion injection using plasma generated from a hydrocarbon gas through a collision of thermoelectrons generated owing to resistance heating of a filament. In this embodiment, while supplying ethylene to the protection film formation chamber in such a manner that 20 sccm of ethylene is supplied to each of the sides of the substrate 2 on which the magnetic film 4 is formed, a substrate bias of −120 V is applied to the substrate 2, and the substrate 2 is irradiated with the plasma at 60 V for 3.6 seconds, so that the carbon protection film is formed on the magnetic film 4.

The thus-prepared samples have an average protection film thickness of 2.8 nm. An automatic ellipsometer manufactured by Photodevice K.K. was used for evaluating a protection film thickness of an outer edge. In order to calculate the protection film thickness using the ellipsometer, each of the samples has been prepared by using the protection film thickness as a parameter, and a correlation of the protection film thickness with an evaluation result obtained by using an X-ray reflection method was found. Used for the film thickness determination by the X-ray reflection method was SLX 2000 TM manufactured by Rigaku Denki Kogyo K.K. It is known that a good correlation is obtained by the evaluation using the ellipsometer. Although it is difficult to evaluate the film thicknesses of the outer radial edge by the X-ray reflection method, the ellipsometer is effective for such evaluation.

In order to understand a film thickness distribution image on the whole surface of the disk, the film thickness distribution has been evaluated by using an OSA (Optical Surface Analyzer) in advance of the ellipsometric evaluation to determine ellipsometric evaluation regions, thereby enabling a thorough evaluation of the film thickness distribution regions.

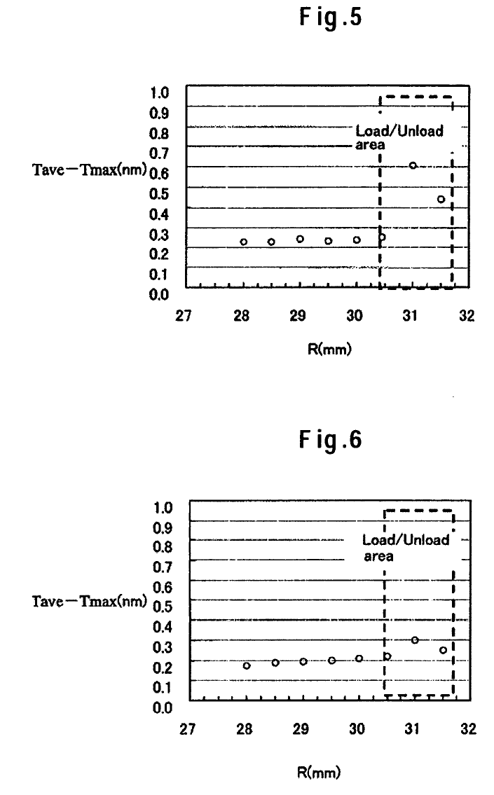

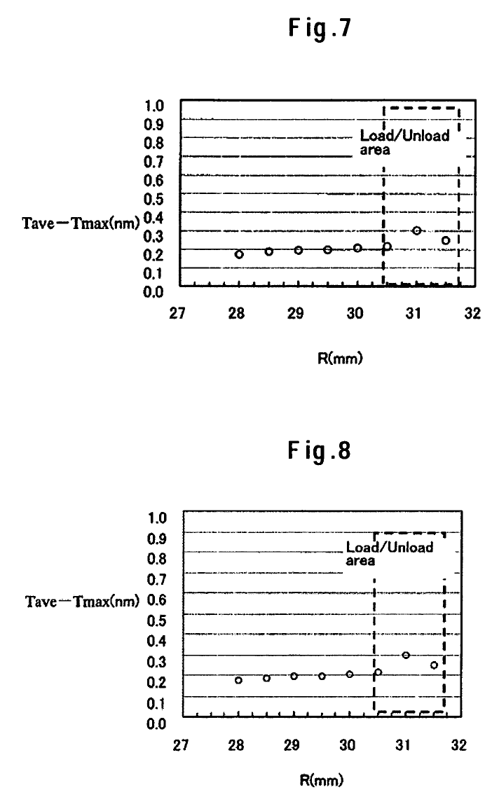

The film thickness distribution in the outer peripheral region of each of the samples manufactured by the above-described methods was evaluated by using the ellipsometer with a pitch of 5° in a circumferential direction and 5 mm in a radial direction. Representative examples of differences between film thickness average values Tave and film thickness maximum values Tmax in the circumferential direction at radial positions R of the magnetic disks are shown in FIGS. 5 to 7. The example when L was 5 mm is shown in FIG. 5; the example when L was 10 mm is shown in FIG. 6; and the example when L was 15 mm is shown in FIG. 7. Each of magnetic disks used in these examples had a diameter of 65 mm, wherein a load/unload zone is set at a radial position R of 30.5 to 31.7 mm.

Referring to FIG. 5, a portion having a larger film thickness is observed near the radial position R of 31 mm where the difference is 0.6 nm. The film thickness difference is reduced to 0.3 nm or less by increasing the value L. In turn, as is apparent from FIGS. 6 and 7, the film thickness difference near the radial position R of 31 mm is improved to 0.3 nm by setting the value L to 10 mm or higher. Therefore, by setting the value L to 10 mm or higher, it is possible to improve the film thickness distribution. This is probably because concentration of the plasma onto the load/unload zone is suppressed by placing the fingers, i.e., metal materials, away from the edge of the substrate 2. However, since the distance from the claws is inevitably increased with the increase in the value L, the substrate tends to fall down due to thermal deformation of the claws when the value L exceeds 15 mm. Therefore, the value of L may preferably be set to about 10 to 15 mm in view of production stability.

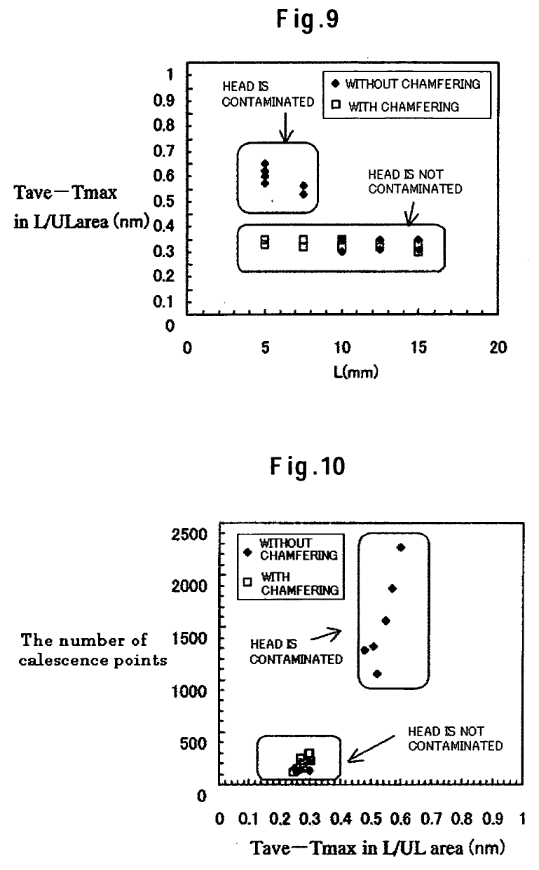

Shown in FIG. 9 is a summary of the relationship between the value L and the difference between the protection film maximum value and the average value in the circumferential direction. Referring to FIG. 9, rhomboid plots connected by a line are the results of this embodiment. As is apparent from FIG. 9, the film thickness difference of 0.3 nm is realized when the value L exceeds 10 mm, whereby the film thickness distribution is improved.

A corrosion resistance evaluation was conducted using the same samples. After the samples were left standing under the conditions of a temperature of 85° C. and a relative humidity of 90% for 96 hours, calescence points on each of the samples were counted by way of an optical microscopic observation. Shown in FIG. 10 is a relationship between the number of calescence points and the difference between the protection film maximum value and the average value in the circumferential direction. FIG. 10 reveals that the number of calescence points is reduced with the reduction in film thickness distribution in the load/unload zone, and thus, the corrosion hardly occurs. More specifically, the corrosion hardly occurs when the film thickness difference is 0.3 nm or less.

Further, a degree of contamination of a head is evaluated by installing each of the magnetic disks 1 in a disk storage unit. The results are shown in FIGS. 9 and 10. Contaminants on the head were observed, and, when the contaminants were found on an inlet and an outlet, the evaluation was expressed as “head is contaminated”. Co was detected in an EDX analysis of the contaminants from each of disks. From FIGS. 9 and 10, it is apparent that the film thickness difference must be 0.3 nm or less in order to avoid the head contamination.

As can be seen from the foregoing, the corrosion and the head contamination are suppressed by setting the difference between the protection film maximum value and the average value in the circumferential direction in the load/unload zone to 0.3 nm or less, thereby making it possible to provide a disk storage unit usable in the high temperature and high humidity environment.

An acceleration evaluation of each of the samples was conducted so as to judge whether or not the sample is reliable as a magnetic disk. In order to evaluate an abrasion resistance in the case of an extremely low head flying height, a motor was subjected to a reverse rotation to bring the head in continuous contact with the magnetic disk. A seek on a zone of 15 to 31 mm of a radius of the magnetic recording medium was performed with the head being in continuous contact with the magnetic recording medium, and a time elapsed until a crush was measured. Each of the disks operated for 60 hours or more without the head crushing, so that satisfactory reliability thereof was confirmed.

Although each of the magnetic disks of this embodiment has the diameter of 65 mm with the load/unload zone thereof being set to the radial position R of 30.5 to 31.7 mm, the same results are obtained from magnetic disks each having the diameter of 48 mm or 84 mm. The load/unload zone of each of the magnetic disks having the diameter of 48 mm and 84 mm is set to a region extending from a substrate outer edge to a radial position of 0.5 to 2 mm.

### Embodiment 2

FIGS. 4A and 4B are each a diagram showing a position relationship between the fingers 7 and the substrate 2 as viewed from above the film formation chamber. In FIG. 4A, a surface of each of the fingers 7 facing the substrate 2 is not processed. In contrast, a surface of each of the fingers 7 facing the substrate 2 is chamfered in FIG. 4B. Plasma which is concentrated on the facet of the finger is kept away from the substrate by reducing a volume of the finger 7 disposed in the vicinity of the substrate 2, thereby making it possible to improve a plasma distribution. In order to prevent the substrate from falling down due to thermal deformation of the fingers, it is preferable to chamfer each of the fingers by ⅓ to ½ of the thickness thereof. The portion of the finger 7 to be chamfered is shown in FIG. 3.

Magnetic disks 1 were manufactured by the method described in the foregoing embodiments except for using the fingers 7 of this embodiment and setting the value L to 5 mm. A film thickness distribution in an outer peripheral zone of each of the samples is evaluated by using the ellipsometer with a pitch of 5° in the circumferential direction and 5 mm in the radial direction in the same manner as described in the foregoing embodiment. Shown in FIG. 8 is a summary of differences between film thickness average values Tave and film thickness maximum values Tmax in the circumferential direction at radial positions R of the magnetic disks. As is apparent from FIG. 8, a film thickness difference of 0.3 nm or less is maintained at each of the radial positions, and a satisfactory film thickness distribution is achieved even when a distance between an edge of the substrate 2 and the finger 7 is short.

Shown in FIG. 9 is a summary of a relationship between the value L and the difference between the protection film maximum value and the average value in the circumferential direction. Referring to FIG. 9, square plots connected by a line are the results of this embodiment. As is apparent from FIG. 9, the film thickness difference of 0.3 nm is realized when the value L is 5 mm or higher.

Results of corrosion resistance evaluation conducted on the same samples under the conditions described in the foregoing embodiment are shown in FIG. 10. In particular, square plots are the results of this embodiment. Since the film thickness difference of a load/unload zone of each of the magnetic disks 1 is 0.3 or less in this embodiment, the number of calescence points is small and the corrosion hardly occurs.

Further, results of evaluation of a degree of contamination on a head, which was conducted in the same manner as in the foregoing embodiment, are shown in FIGS. 9 and 10. In particular, square plots are the results of this embodiment. From FIGS. 9 and 10, it is confirmed that the film thickness difference in the load/unload zone of the magnetic disk 1 must be kept at 0.3 nm or less in order to avoid the head contamination.

It is possible to achieve a similar effect by reducing a volume of a component disposed in the vicinity of the substrate 2 by employing processing methods other than the chamfering, such as rounding, without limitation to the chamfering of the finger 7.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A method for manufacturing a magnetic disk, comprising:
forming an underlying layer on a substrate;
forming a magnetic film on the underlying layer; and
forming a protection film by deposition on the magnetic film;
wherein
the substrate is mounted on a holder having a claw for holding the substrate and a supporting member that supports the claw during formation of the protection film, and
a shortest distance between the substrate and the supporting member is about 10 mm or more.

2. The magnetic disk manufacturing method according to claim 1, wherein the shortest distance is about 15 mm or less.

3. The magnetic disk manufacturing method according to claim 1, wherein the protection film has a film thickness of about 4 nm or less.

4. The magnetic disk manufacturing method according to claim 1, wherein the protection film is formed by chemical vapor deposition.

5. The magnetic disk manufacturing method according to claim 1, wherein the magnetic disk has a diameter of 48 to 84 mm.

6. A method for manufacturing a magnetic disk, comprising:
forming an underlying layer on a substrate;
forming a magnetic film on the underlying layer; and
forming a protection film by deposition on the magnetic film;
wherein
the substrate is mounted on a holder having a claw for holding the substrate and a supporting member that supports the claw during formation of the protection film,
a surface, of the supporting member, facing the substrate is chamfered, and
a shortest distance between the substrate and the supporting member is about 5 mm or more.

7. The magnetic disk manufacturing method according to claim 6, wherein the shortest distance is about 15 mm or less.

8. The magnetic disk manufacturing method according to claim 6, wherein the protection film has a film thickness of about 4 nm or less.

9. The magnetic disk manufacturing method according to claim 6, wherein the protection film is formed by chemical vapor deposition.

10. The magnetic disk manufacturing method according to claim 6, wherein the magnetic disk has a diameter of 48 to 84 mm.

11. A magnetic disk comprising:
a substrate;
an underlying layer formed on the substrate;
a magnetic film formed on the underlying layer; and
a protection film formed on the magnetic film;
wherein a film thickness distribution in a load/unload zone of the protection film is about 0.3 nm or less.

12. The magnetic disk according to claim 11, wherein the protection film has a film thickness of about 4 nm or less.

13. The magnetic disk according to claim 11, wherein the load/unload zone of the protection film is disposed near an outer radial edge of the protection film with respect to a center of the protection film.

14. The magnetic disk according to claim 13, wherein the load/unload zone extends radially inward from the outer radial edge of the protection film by 0.5 to 2 mm.

15. The magnetic disk according to claim 11, wherein the magnetic disk has a diameter of 48 mm to 84 mm.
